(19) United States
(12) Patent Application Publication
(10) Pub. No.: US 2026/0253165 A1
(43) Pub. Date: Aug. 27, 2026

(54) GRAPHICS PROCESSING

(71) Applicant: Arm Limited, Cambridge (GB)

(72) Inventors: Daren Croxford, Swaffham Prior (GB); Graeme Leslie Ingram, Melbourn (GB); Rémy Pottier, Grenoble (FR)

(73) Assignee: Arm Limited, Cambridge (GB)

(21) Appl. No.: 19/065,899

(22) Filed: Feb. 27, 2025

(51) Int. Cl. G06T 1/20; G06F 13/28

(52) U.S. Cl. CPC G06T 1/20; G06F 13/28

(57) ABSTRACT

A graphics accelerator is disclosed that comprises a set of plural data transfer channels operable to transfer data. Two or more of the data transfer channels are associated with each other, and caused to transfer data at respective data transfer rates in accordance with a particular data transfer rate ratio.

### BACKGROUND

The technology described herein relates to computer graphics processing, and in particular to “2-D” graphics acceleration.

When software executing on a host processor CPU requires the display of frames (images) on a display, the host processor CPU may “offload” graphics processing operations to a graphics accelerator (GPU). The graphics accelerator may generate the required frames (images), and store them in appropriate frame buffers in memory. A display controller may then read the frame buffers and cause the frames (images) to be displayed by the display.

In 3-D graphics processing, a high performance 3-D graphics accelerator (GPU) will normally render frames (images) for display by splitting a 3-D model into a number of similar basic components or “primitives”, and performing 3-D graphics processing operations, such as rasterisation, fragment shading, ray tracing, etc.

For some applications, such as graphical user interfaces (GUIs), 3-D graphics processing operations may not be necessary, and a lower performance, “2-D”, graphics accelerator (GPU) may be provided for graphics acceleration. A lower performance (“2-D”) graphics accelerator (GPU) will usually be designed to perform less complex graphics processing operations, such as blitting (block image transfer), scaling, compositing, etc., and will accordingly normally be less expensive to implement than a high performance 3-D graphics processor (GPU).

The inventors believe that there remains scope for improvements to lower performance (“2-D”) graphics accelerators and processing systems.

### BRIEF DESCRIPTION OF THE DRAWINGS

Embodiments of the technology described herein will now be described by way of example only and with reference to the accompanying drawings, in which:

FIG. 1 shows an exemplary “3-D” graphics processing system;

FIG. 2 shows an exemplary “2-D” graphics processing system which may be operated in accordance with embodiments;

FIG. 3 shows an exemplary “2-D” graphics accelerator sub-system which may be operated in accordance with embodiments;

FIG. 4 shows an exemplary DMA controller which may be operated in accordance with embodiments;

FIG. 5 shows an exemplary colour space conversion processor;

FIG. 6 illustrates YUV420 image format;

FIG. 7 shows a process in accordance with embodiments;

FIG. 8 shows an exemplary image composition operation; and

FIG. 9 shows an exemplary “2-D” graphics processing system in accordance with embodiments.

### DETAILED DESCRIPTION

A first embodiment of the technology described herein comprises a graphics accelerator (processor) comprising:
a data transfer circuit having a set of plural data transfer channels operable to transfer data; and
a control circuit operable to:
   associate two or more data transfer channels of the set of plural data transfer channels with each other; and
   cause the associated two or more data transfer channels to transfer data at respective data transfer rates in accordance with a particular data transfer rate ratio.

A second embodiment of the technology described herein comprises a method of operating a graphics accelerator (processor) that comprises a data transfer circuit having a set of plural data transfer channels operable to transfer data; the method comprising:
associating two or more data transfer channels of the set of plural data transfer channels with each other; and
causing the associated two or more data transfer channels to transfer data at respective data transfer rates in accordance with a particular data transfer rate ratio.

The technology described herein relates to a graphics accelerator (e.g. graphics processing unit (GPU)) that comprises a data transfer circuit (e.g. a Direct Memory Access (DMA) controller) that has plural data transfer (e.g. DMA) channels that are (each) operable to transfer data, e.g. between different memory locations. The graphics accelerator (processor) is, in embodiments, a lower performance, “2-D”, graphics accelerator (“2-D” graphics processor (GPU)) that is operable to generate frames (images) for display using (e.g. predominantly) “2-D” graphics processing operations. For example, and in embodiments, the graphics accelerator (processor) is operable to generate a frame (image) for display by one or more of the data transfer (e.g. DMA) channels transferring image data between different memory locations, e.g. to thereby generate the frame (image) by “blitting”.

Typically, DMA channels operate independently of each other, and such that each DMA channel will attempt to transfer data it has been asked to transfer at as fast a data transfer rate as possible. The inventors have realised, however, that for some 2-D graphics processing operations, it can be advantageous to be able to configure different DMA channels to transfer related data in a coordinated manner. For example, and as will be discussed in more detail below, when performing colour space conversion, it may be desirable to be able to coordinate the transfer over separate DMA channels of different colour channels of an image. Similarly, when performing image compositing, it may be desirable to be able to coordinate the transfer over separate DMA channels of different image elements (e.g. windows) that are to be composited.

In the technology described herein, different data transfer (e.g. DMA) channels can be associated with each other, e.g. “bonded” together, and configured to transfer data in accordance with a particular (e.g. selected, e.g. predetermined) ratio of data transfer rates. Thus, the rate at which one data transfer (e.g. DMA) channel transfers data can be controlled to be a particular proportion/fraction of the rate at which another, associated (bonded) data transfer (e.g. DMA) channel transfers data.

As will be discussed in more detail below, this can allow “2-D” graphics processing operations, such as image compositing and colour space conversion, to be performed in a coordinated and efficient manner. For example, different data transfer (e.g. DMA) channels can be associated (bonded) with each other and configured with relative data transfer rates such that they will transfer related data in substantially the same amount of time, e.g. even where there are different amounts of related data to be transferred by the different data transfer (e.g. DMA) channels.

This can reduce or avoid buffering requirements (and thus hardware/silicon area costs) that may otherwise be required e.g. to buffer data transferred by one data transfer (e.g. DMA) channel while waiting for related data to be transferred by an associated data transfer (e.g. DMA) channel.

It will be appreciated, therefore, that the technology described herein can facilitate improved (2-D) graphics acceleration.

In embodiments, the graphics accelerator forms part of a graphics processing system that also comprises a host processor, e.g. a central processing unit (CPU). The host processor CPU may execute applications that can require graphics processing by the graphics accelerator, and send appropriate commands and data to the graphics accelerator to control it to perform graphics processing operations and to produce graphics processing output required by applications executing on the host processor CPU.

To facilitate this, the host processor CPU in embodiments also executes a driver for the graphics accelerator. Thus, in embodiments, the graphics processing system comprises a graphics accelerator that is in communication with a host microprocessor (CPU) that executes a driver for the graphics accelerator.

The graphics accelerator can be any suitable processor that may perform graphics processing operations for the host processor CPU to produce a suitable graphics processing output.

In embodiments, the graphics accelerator is operable to generate output frames (images) for display. A frame (image) for display will typically comprise an array of data elements (sampling points) (e.g. pixels), for each of which appropriate output data (e.g. a set of colour value data) is generated by the graphics accelerator. An output frame (image) may comprise colour data, for example, a set of red, green and blue, RGB values and a transparency (alpha, a) value. Where the graphics accelerator generates plural (e.g. a series of) frames, each frame may be generated in accordance with the technology described herein.

In embodiments, the graphics accelerator is a “2-D” graphics accelerator (processor) that is operable to generate frames (images) for display using (e.g. predominantly) “2-D” graphics processing operations. Thus, in embodiments, the graphics accelerator is not specifically designed to efficiently perform 3-D graphics processing operations, such as rasterisation, fragment shading, ray tracing, etc. (although it may be able to perform at least some 3-D graphics processing operations).

In embodiments, the (2-D) graphics accelerator can generate an output frame (image) for display by one or more of the data transfer channels transferring (copying) one or more regions (e.g. blocks) of image data from one or more source memory regions (e.g. source buffers) to an output memory region (e.g. frame buffer). The (2-D) graphics accelerator is thus, in embodiments, operable as a blitter.

The graphics accelerator comprises a data transfer circuit having a set of plural data transfer channels that, in embodiments, can each transfer (image) data independently of each other data transfer channel of the set. In embodiments, the data transfer circuit is a DMA controller, and each data transfer channel is a DMA channel. In embodiments, the data transfer circuit (e.g. DMA controller) comprises a (the) control circuit which is operable to associate two or more data transfer (e.g. DMA) channels, and cause the associated two or more data transfer (e.g. DMA) channels to transfer data at respective data transfer rates in accordance with a particular data transfer rate ratio.

In embodiments, the graphics accelerator further comprises a CPU that is e.g. operable to receive commands and data from the host processor CPU, and in response, control the data transfer circuit (e.g. DMA controller) to perform data transfer (e.g. DMA) operations, e.g. to transfer (image) data between memory locations in accordance with the commands and data. The CPU of the graphics accelerator may be (further) operable to perform (e.g. graphics) processing operations, data transfer operations, etc., e.g. by executing software.

Thus, in embodiments, the graphics accelerator comprises a Central Processing Unit (CPU), and a Direct Memory Access (DMA) controller comprising the set of plural (DMA) channels (and the control circuit). In embodiments, the data transfer circuit (e.g. DMA controller) comprises a data transfer (e.g. DMA) request interface that is operable to receive data transfer (e.g. DMA) requests from the CPU (and cause the data transfer circuit to transfer data accordingly).

In embodiments, the data transfer circuit (e.g. DMA controller) can indicate to the CPU when a data transfer (e.g. DMA) operation has been completed, e.g. by issuing an appropriate interrupt to the CPU. In embodiments, the data transfer circuit (e.g. DMA controller) comprises an interrupt interface that is operable to issue such interrupts. To facilitate interrupt handling, the graphics accelerator may further comprise an interrupt controller in communication with the CPU and the (interrupt interface of the) data transfer circuit (e.g. DMA controller) of the graphics accelerator.

The plural data transfer (e.g. DMA) channels should be, and in embodiments are, in communication with a memory system. Thus, in embodiments, the graphics processing system (further) comprises a memory system that (each of) the data transfer channels can (independently) access, e.g. to transfer (image) data to and/or from. In embodiments, a (each) CPU can also access the memory system.

The memory system may be arranged in any suitable manner. In embodiments, the memory system comprises (at least) a main (system) memory that is, in embodiments, an external memory, e.g. not on the same chip as the graphics accelerator and/or the host processor CPU. The memory system may (further) comprise one or more cache systems (hierarchies), one or more buffers, etc.

In embodiments, the graphics processing system comprises a communications bus (interconnect) in communication with (at least) the graphics accelerator and the (main) memory (and the host processor CPU), and via which the data transfer channels of the graphics accelerator (and a (each) CPU) can (each) access the memory system. The communications bus can be any suitable and desired interconnect, e.g. over which bus transactions to access the (e.g. main) memory can be performed by the data transfer circuit (and a (each) CPU).

In embodiments, the data transfer circuit (e.g. DMA controller) comprises one or more memory interfaces (e.g. bus adapters) in communication with the communications bus (interconnect) (and thus the memory). In embodiments, (each of) the data transfer channels are in communication with the memory system via the one or more memory interfaces (and the communications bus (interconnect)), and can transfer (image) data to and/or from the memory system via the one or more memory interfaces (and the communications bus (interconnect)).

Thus, in embodiments, the data transfer circuit (e.g. DMA controller) comprises one or more memory interfaces for communicating with the memory system, and the associated two or more channels are caused (by the control circuit) to transfer data to and/or from the memory system via the one or more memory interfaces at respective data transfer rates in accordance with the particular data transfer rate ratio. In embodiments, data is fetched from the memory system or stored in the memory system for associated data transfer channels of the data transfer circuit (e.g. DMA controller) at respective rates in accordance with the particular data transfer rate ratio.

The set of plural data transfer (e.g. DMA) channels of the data transfer circuit (e.g. DMA controller) can comprise any suitable number of data transfer channels, such as two, four, eight, sixteen, or another number.

A (each) data transfer (e.g. DMA) channel of the data transfer circuit (e.g. DMA controller) can be arranged in any suitable and desired manner. In embodiments, a (each) channel is associated with (e.g. comprises) data storage for temporarily storing (buffering) data being transferred by the (respective channel), e.g. comprising one or more FIFO buffers. A (each) channel may be (further) associated with (e.g. comprises) configuration storage for storing configuration data for the (respective) channel, e.g. comprising one or more registers. A (each) channel may be (further) associated with (e.g. comprises) a channel control circuit configured to cause the (respective) channel to transfer data in accordance with configuration data stored in the configuration storage for the (respective) channel.

In embodiments, a (each) data transfer (e.g. DMA) channel can be caused to perform one or more data transfer (e.g. DMA) operations by (the control circuit) setting (e.g. writing) appropriate configuration data to the configuration storage for the (respective) data transfer channel. Configuration data may, for example, identify (source) data to be transferred and a destination for the data to be transferred to, and may be set (written) appropriately by the control circuit, e.g. in response to a request received from the CPU of the graphics accelerator, e.g. so as to cause the channel to transfer (image) data in accordance with the request. Configuration data may, for example, indicate a single data transfer (e.g. DMA) operation to be performed by a data transfer (e.g. DMA) channel, or a sequence of plural data transfer operations to be performed by a data transfer (e.g. DMA) channel.

In embodiments, configuration data for a (each) channel (further) comprises information indicating which (if any) other channel(s) the (respective) channel is associated (e.g. bonded) with. The configuration data may (further) comprise information indicating a (the) particular data transfer rate ratio.

Thus, in embodiments, data transfer (e.g. DMA) channels are associated (bonded) with each other by (the control circuit) setting (writing) configuration data for the channels that indicates that the channels are associated (bonded) with each other. In embodiments, associated (bonded) channels are caused to transfer data at respective data transfer rates in accordance with a particular data transfer rate ratio by (the control circuit) setting (writing) configuration data for the associated (bonded) channels that indicates the particular data transfer rate ratio.

A (each) data transfer channel may access the memory system (to transfer data) in any suitable manner. In embodiments, a (each) (channel control circuit of a) data transfer channel can (e.g. in accordance with corresponding configuration data) cause the one or more memory interfaces of the data transfer circuit to issue read and/or write requests to the memory system (via the communications bus), which requests may indicate data to be read/written and one or more memory locations (addresses) indicating where the data is to be read from/written to. In embodiments, the one or more memory interfaces of the data transfer circuit issue read/write requests for data transfer (e.g. DMA) channels that are associated with each other such that data will be transferred at respective data transfer rates in accordance with a (the) particular data transfer rate ratio (indicated by configuration data for the channels).

In embodiments, a (each) request issued by a memory interface of the data transfer circuit (also) indicates an identifier (ID) for the transaction. In embodiments, the memory system is configured such that it will respond to requests that have the same transaction identifier (ID) “in-order”, i.e. in the order in which the requests are received, whereas it may respond to requests that have different transaction IDs “out-of-order”, i.e. in a different order to the order in which the requests are received. In embodiments, the one or more memory interfaces of the data transfer circuit issue requests to the memory system using the same transaction ID in respect of data transfer channels that are associated (bonded) with each other, e.g. such that the memory system responds “in-order” to requests for the associated (bonded) channels. Thus, in embodiments, requests to the memory system for the associated two or more data transfer channels are caused (by the control circuit) to use a same transaction identifier (ID). This can (further) reduce buffering requirements.

The graphics accelerator could comprise e.g. only a CPU and DMA controller, and e.g. generate output frames (images) for display (only) by the CPU executing software and the DMA channels transferring (copying) image data appropriately (e.g. performing blitting). However, in embodiments, the graphics accelerator comprises, or is in communication with, one or more further data processors operable to perform one or more further (e.g. graphics) processing operations for the graphics accelerator, such as, and in embodiments, colour space conversion, image compositing, etc.

In embodiments, the one or more further data processors are in (direct) communication with the data transfer circuit (e.g. DMA controller) of the graphics accelerator, and data transfer (e.g. DMA) channels of the data transfer circuit can transfer (image) data to a further data processor for processing (e.g. from the memory system), and transfer processed (image) data from a further data processor (e.g. to the memory system). Thus, in embodiments, a (each) data transfer channel of the data transfer circuit (e.g. DMA controller) can be caused (by the control circuit) to perform one or more data transfer operations to transfer data between the memory system and a further data processor.

To facilitate this, in embodiments, the data transfer circuit (e.g. DMA controller) comprises one or more “streaming” interfaces in (direct) communication with the one or more (further) data processors. In embodiments, data can be transferred via a “streaming” interface directly, e.g. without being stored in memory. In embodiments, (each of) the data transfer channels can communicate with the one or more (further) data processors via the one or more “streaming” interfaces, and can transfer (image) data to and/or from the one or more (further) data processors via the one or more “streaming” interfaces.

Correspondingly, in embodiments, the one or more further data processors can receive (image) data transferred by a data transfer channel of the data transfer circuit via the one or more “streaming” interfaces, process the (image) data, and return processed (image) data to a data transfer channel of the data transfer circuit via the one or more “streaming” interfaces.

Thus, in embodiments, the data transfer circuit comprises one or more (“streaming”) interfaces for communicating (directly) with one or more (further) data processors, and the associated two or more channels are caused (by the control circuit) to transfer data to and/or from the one or more (further) data processors via the one or more (“streaming”) interfaces at data transfer rates in accordance with the particular data transfer rate ratio. In embodiments, data is sent to a (further) data processor or received from a (further) data processor for associated data transfer channels of the data transfer circuit (e.g. DMA controller) at rates in accordance with the particular data transfer rate ratio.

A (further) data processor may be any suitable circuit that can perform any suitable and desired (e.g. graphics) processing operation(s) for the graphics accelerator. In embodiments a (further) data processor is a specific purpose hardware unit operable to perform one or more specific (e.g. graphics) processing operations for the graphics accelerator. For example, and in embodiments, a (further) data processor is a colour space conversion circuit operable to perform colour space conversion for the graphics accelerator. Thus, in embodiments, the data transfer circuit transfers image data having a first colour space representation (e.g. from the memory system) to the colour space conversion circuit (via the one or more “streaming” interfaces), the colour space conversion circuit performs colour space conversion to convert the first colour space representation to a second, different colour space representation, and the data transfer circuit may transfer image data having the second colour space representation (e.g. to the memory system) from the colour space conversion circuit (via the one or more “streaming” interfaces). The first colour space representation may, for example, comprise a YUV representation, and the second colour space representation may, for example, comprise a RGB representation. Other arrangements are possible.

In embodiments, a (further) data processor is an image compositing circuit operable to perform image compositing for the graphics accelerator. Thus, in embodiments, the data transfer circuit transfers image element data (e.g. from the memory system) to the image compositing circuit (via the one or more “streaming” interfaces), the image compositing circuit performs image compositing to e.g. blend the image element data, and the data transfer circuit may transfer composited image data (e.g. to the memory system) from the image compositing circuit (via the one or more “streaming” interfaces). An image element to be composited may, for example, comprise a window or background image, e.g. for a graphical user interface (GUI).

As will be discussed in more detail below, a (further) data processor may (also) be operable as a display processor to cause frames (images) generated by the graphics accelerator to be displayed on a display. Other arrangements are possible.

In the technology described herein two or more data transfer (e.g. DMA) channels of the data transfer circuit (e.g. DMA controller) are associated with each other (e.g. bonded together), and caused to transfer data in accordance with a particular data transfer rate ratio. There may be only one subset of channels of the set of channels that are associated (bonded) with each other, or two or more different subsets of channels of the set of channels may be associated (bonded) with each other. Thus, for example, a first two or more data transfer channels of the data transfer circuit may be associated with each other (e.g. bonded together), and caused to transfer data in accordance with a first particular data transfer rate ratio, and a second two or more data transfer channels of the data transfer circuit may be associated with each other (e.g. bonded together), and caused to transfer data in accordance with a second particular data transfer rate ratio, etc.

The data that is transferred over data transfer channels that are associated with each other (e.g. bonded together) can be any suitable data that is transferred for any suitable purpose. In embodiments, associated data transfer channels transfer related data, and in embodiments related image data. In embodiments, associated data transfer channels transfer related (image) data that is stored separately (in separate memory regions (buffers)).

For example, a first data transfer channel may transfer a first colour component for an image, and a second, associated data transfer channel may transfer a second colour component for the image (e.g. which colour components are stored separately (in separate memory regions (buffers))). For example, and in embodiments, in the case of YUV image data, a first data transfer channel may transfer luma (Y) data, and a second associated channel may transfer corresponding chroma data (UV). Alternatively, a first channel may transfer luma (Y) data, and second and third associated channels may transfer corresponding chroma data (UV). In the case of RGB image data, a first channel may transfer red data (R), a second associated channel may transfer corresponding green data (G), and a third associated channel may transfer corresponding blue data (B), etc.

For example, in the case of colour space conversion, where different colour components for a colour space representation are stored separately in the memory system, different colour components may be transferred from the memory system to the colour space conversion circuit using different associated (bonded) data transfer channels of the data transfer circuit.

Alternatively, a first data transfer channel may transfer a first image element for an image, and a second, associated data transfer channel may transfer a second image element for the image (e.g. which image elements are stored separately (in separate memory regions (buffers))). For example, in the case of image compositing, where different image elements to be composited are stored separately in the memory system, the different image elements may be transferred from the memory system to the image compositing circuit using different associated (bonded) data transfer channels of the data transfer circuit. Other arrangements are possible.

Thus, in embodiments, different associated (bonded) data transfer channels of the data transfer circuit are caused (by the control circuit) to transfer (separately stored) related image data, e.g. between a (further) data processor and the memory system. In embodiments, the associated (bonded) data transfer channels transfer related (image) data simultaneously. This can facilitate efficient data transfer between the memory system and (further) data processor, for example.

The particular data transfer rate ratio at which associated (bonded) data transfer channels transfer data can be selected as desired. The particular data transfer rate ratio should be, and in embodiments is, a ratio of two or more (different) data transfer rates (at which two or more data transfer channels transfer data).

A (the) particular data transfer rate ratio may be indicated (e.g. by configuration data) in any suitable manner. A ratio may, for example, be specified by a least two numbers (e.g. 3 and 2), an ordered set of at least two numbers (e.g. 3:2), a fraction (e.g. 3/2), a value of a quotient (e.g. 1.5), etc. A ratio may be specified in simplified form (e.g. 3:2) or not in simplified form (e.g. 9:6), etc. A (the) particular data transfer rate ratio may be indicated by specifying data transfer rates, or by specifying numbers proportional to desired data transfer rates (e.g. amounts of data to be transferred or another quantity), etc.

Where two data transfer channels are associated with each other, the particular data transfer rate ratio may be a “two-term” ratio, i.e. a ratio of a first data transfer rate at which a first data transfer channel of the associated two or more data transfer channels transfers data to a second data transfer rate at which a second data transfer channel of the associated two or more data transfer channels transfers data, such as 1:1, 2:1, 3:1, 3:2, 4:1, etc. Where three data transfer channels are associated with each other, the particular data transfer rate ratio may be a “three-term” ratio, i.e. a ratio of a first data transfer rate at which a first data transfer channel of the associated two or more data transfer channels transfers data, to a second data transfer rate at which a second data transfer channel of the associated two or more data transfer channels transfers data, to a third data transfer rate at which a third data transfer channel of the associated two or more data transfer channels transfers data, such as 1:1:1, 2:1:1, 2:2:1, etc. Where four or more data transfer channels are associated with each other, the particular data transfer rate ratio may be a “four or more-term” ratio, etc.

Where there are the same (or similar) amounts of (related) data to be transferred by associated (bonded) data transfer channels, the associated (bonded) data transfer channels may transfer the data at substantially the same data transfer rate. Where there are different amounts of (related) data to be transferred by different associated (bonded) data transfer channels, in embodiments, the particular data transfer rate ratio is selected based on the different amounts of related data to be transferred, and in embodiments such that the different amounts of related data will take substantially the same amount of time to transfer as each other.

Thus, in embodiments, the particular data transfer rate ratio is based on amounts of related data to be transferred by the associated (bonded) data transfer channels, and in embodiments is such that transfer of the related data over the associated (bonded) data transfer channels will take (substantially) the same amount of time.

For example, and in embodiments, in the case of transferring chroma-subsampled YUV image data (e.g. to a colour space conversion circuit for colour space conversion), where chroma data is stored at a lower resolution than corresponding luma data, the particular data transfer rate ratio may be such that luma data and chroma data for an image are transferred over separate data transfer channels in substantially the same amount of time. In the case of transferring different sized image elements to be composited (e.g. to an image compositing circuit for image compositing), the particular data transfer rate ratio may be such that different sized image elements are transferred over separate data transfer channels in substantially the same amount of time.

Thus, in embodiments, the particular data transfer rate ratio is based on image resolution and/or size associated with related image data that is to be transferred over separate data transfer channels. In embodiments, the particular data transfer rate ratio is based on a resolution at which different colour components (that are to be transferred over separate data transfer channels) are represented. In embodiments, the particular data transfer rate ratio is based on sizes of image elements (that are to be transferred over separate data transfer channels) to be composited. Other arrangements are possible.

In embodiments, output frame (images) generated by the graphics accelerator are provided to a display for display. To facilitate this, in embodiments, the graphics processing system comprises a display processor that is operable to provide output frames (images) generated by the graphics accelerator for display by a display. In embodiments, the graphics accelerator writes output frames (images) to (e.g. a frame buffer in) the memory system, and the display processor reads the output frames (images) from (the frame buffer in) the memory system and causes the frame (images) to be displayed on the display.

In other embodiments, a (further) data processor that is in (direct) communication with the data transfer circuit (e.g. DMA controller) is operable as the display processor. Thus, in embodiments, a (further) data processor is operable to provide output frames (images) generated by the graphics accelerator for display by a display. The (further) data processor may also perform one or more further data processing operations, such as colour space conversion, image compositing, etc., e.g. as described above.

Thus, in embodiments, the data transfer circuit (e.g. DMA controller) transfers (image) data (e.g. from the memory system) to a (further) data processor (via the one or more “streaming” interfaces), the (further) data processor performs one or more data processing operations (such as image compositing and/or colour space conversion) on the transferred data to generate an output frame (image) for display, and the (further) data processor causes the output frame (image) to be displayed on a display (e.g. without the output frame (image) being written to (a frame buffer in) the memory system).

Another embodiment of the technology described herein comprises a data transfer circuit (e.g. DMA controller) comprising:
a set of plural data transfer channels operable to transfer data; and
a control circuit operable to:
   associate two or more data transfer channels of the set of plural data transfer channels with each other; and
   cause the associated two or more data transfer channels to transfer data at respective data transfer rates in accordance with a particular data transfer rate ratio.

Another embodiment of the technology described herein comprises a method of operating a data transfer circuit (e.g. DMA controller) having a set of plural data transfer channels operable to transfer data; the method comprising:
associating two or more data transfer channels of the set of plural data transfer channels with each other; and
causing the associated two or more data transfer channels to transfer data at respective data transfer rates in accordance with a particular data transfer rate ratio.

These embodiments can, and in embodiments do, include one or more, and in embodiments all, features of other embodiments of the technology described herein, as appropriate.

The technology described herein can be implemented in any suitable system, such as a suitably operable micro-processor based system. In some embodiments, the technology described herein is implemented in a computer and/or micro-processor based system.

The various functions of the technology described herein can be carried out in any desired and suitable manner. For example, the functions of the technology described herein can be implemented in hardware or software, as desired. Thus, for example, the various functional elements, stages, units, and “means” of the technology described herein may comprise a suitable processor or processors, controller or controllers, functional units, circuitry, circuits, processing logic, microprocessor arrangements, etc., that are operable to perform the various functions, etc., such as appropriately dedicated hardware elements (processing circuits/circuitry) and/or programmable hardware elements (processing circuits/circuitry) that can be programmed to operate in the desired manner.

It should also be noted here that the various functions, etc., of the technology described herein may be duplicated and/or carried out in parallel on a given processor. Equally, the various processing stages may share processing circuits/circuitry, etc., if desired.

Furthermore, any one or more or all of the processing stages or units of the technology described herein may be embodied as processing stage or unit circuits/circuitry, e.g., in the form of one or more fixed-function units (hardware) (processing circuits/circuitry), and/or in the form of programmable processing circuitry that can be programmed to perform the desired operation. Equally, any one or more of the processing stages or units and processing stage or unit circuits/circuitry of the technology described herein may be provided as a separate circuit element to any one or more of the other processing stages or units or processing stage or unit circuits/circuitry, and/or any one or more or all of the processing stages or units and processing stage or unit circuits/circuitry may be at least partially formed of shared processing circuit/circuitry.

It will also be appreciated by those skilled in the art that all of the described embodiments of the technology described herein can include, as appropriate, any one or more or all of the optional features described herein.

The methods in accordance with the technology described herein may be implemented at least partially using software e.g. computer programs. Thus, further embodiments of the technology described herein comprise computer software specifically adapted to carry out the methods herein described when installed on a data processor, a computer program element comprising computer software code portions for performing the methods herein described when the program element is run on a data processor, and a computer program comprising code adapted to perform all the steps of a method or of the methods herein described when the program is run on a data processing system. The data processing system may be a microprocessor, a programmable FPGA (Field Programmable Gate Array), etc.

The technology described herein also extends to a computer software carrier comprising such software which when used to operate a graphics processor, renderer or other system comprising a data processor causes in conjunction with said data processor said processor, renderer or system to carry out the steps of the methods of the technology described herein. Such a computer software carrier could be a physical storage medium such as a ROM chip, CD ROM, RAM, flash memory, or disk, or could be a signal such as an electronic signal over wires, an optical signal or a radio signal such as to a satellite or the like.

It will further be appreciated that not all steps of the methods of the technology described herein need be carried out by computer software and thus further embodiments of the technology described herein comprise computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions fixed on a tangible, non-transitory medium, such as a computer readable medium, for example, diskette, CD ROM, ROM, RAM, flash memory, or hard disk. It could also comprise a series of computer readable instructions transmittable to a computer system, via a modem or other interface device, over a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink wrapped software, pre-loaded with a computer system, for example, on a system ROM or fixed disk, or distributed from a server or electronic bulletin board over a network, for example, the Internet or World Wide Web.

Embodiments of the technology described herein will now be described with reference to the drawings.

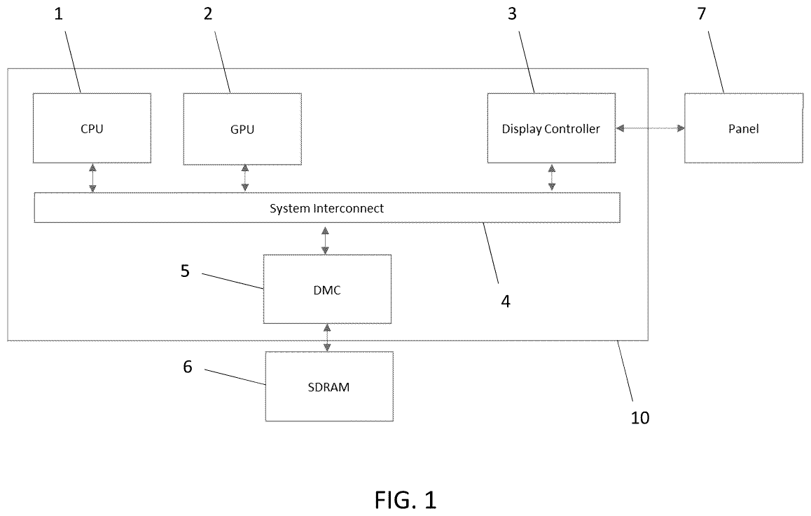

FIG. 1 shows an exemplary system on chip (SoC) 3-D graphics processing system 10 that comprises a host processor comprising a central processing unit (CPU) 1, a graphics processor (GPU) 2, a display processor 3, and a memory controller 5. As shown in FIG. 1, these units communicate via an interconnect 4 and have access to off-chip memory 6.

In use of this system, an application such as a game, executing on host processor (CPU) 1 will, for example, require the display of frames on the display panel 7. To do this, the application will submit appropriate commands and data to a driver for the graphics processor 2 that is executing on a CPU 1. The driver will then generate appropriate commands and data to cause the graphics processor 2 to render appropriate frames for display and to store those frames in appropriate frame buffers in the main memory 6. The display processor 3 will then read those frames into a buffer for the display from where they are then read out and displayed on the display panel 7 of the display.

In this 3-D computer graphics processing system 10, graphics processor (GPU) 2 will typically render frames (images) to be displayed by splitting a 3-D model of a scene into a number of similar basic components or “primitives”, and then subjecting the primitives to a 3-D rendering process, e.g. comprising rasterisation, fragment shading, ray tracing, etc. Such 3-D graphics processing acceleration can be relatively expensive to implement, and may not always be necessary.

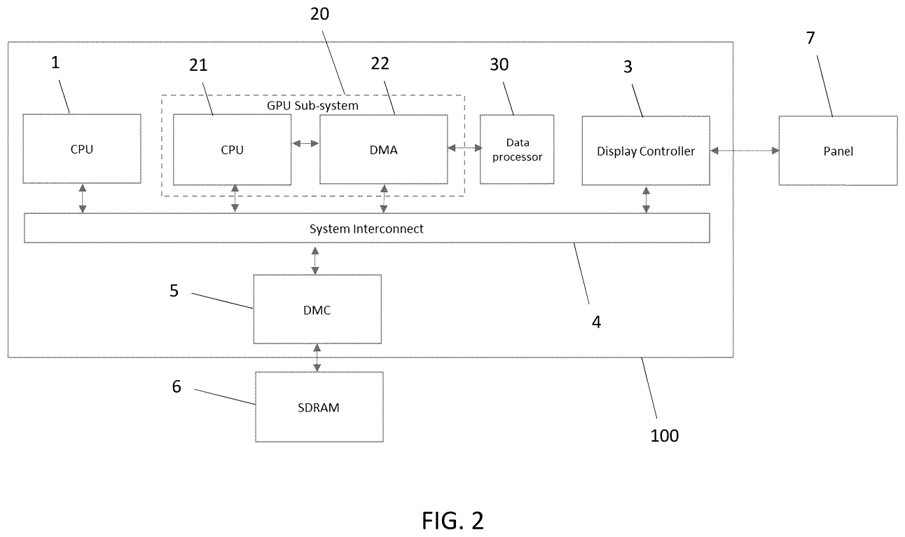

FIG. 2 illustrates an exemplary system on chip (SoC) “2-D” graphics processing system 100, which may be operated in accordance with embodiments of the technology described herein. As illustrated in FIG. 2, “2-D” graphics processing system 100 may be arranged substantially as described above, but comprises a, e.g. lower performance, “2-D” graphics sub-system (accelerator) 20 comprising a central processing unit (CPU) 21 and a Direct Memory Access (DMA) controller 22. As illustrated in FIG. 2, the system 100 may further comprise data processor 30 in communication with DMA controller 22. As will described in more detail below, data processor 30 may be a specific purpose hardware unit configured to perform colour space conversion, image compositing, or another data processing operation.

In this system, “2-D” graphics sub-system 20 can (e.g. in conjunction with data processor 30) generate frames (images) to be displayed using (e.g. predominantly) “2-D” computer graphics processing operations, such as image composition, blending, scaling, blitting (block image transfer), etc. “2-D” graphics sub-system 20 may generate such frames (images) in response to commands and data from a driver for the “2-D” graphics sub-system 20 that is executing on the host processor CPU 1, and store such frames (images) in appropriate frame buffers in the main memory 6. The display processor 3 can then read those frames into a buffer for the display from where they are then read out and displayed on the display panel 7 of the display. Such “2-D” graphics processing acceleration can be significantly cheaper to implement than full, higher performance 3-D graphics processing acceleration, e.g. as described above.

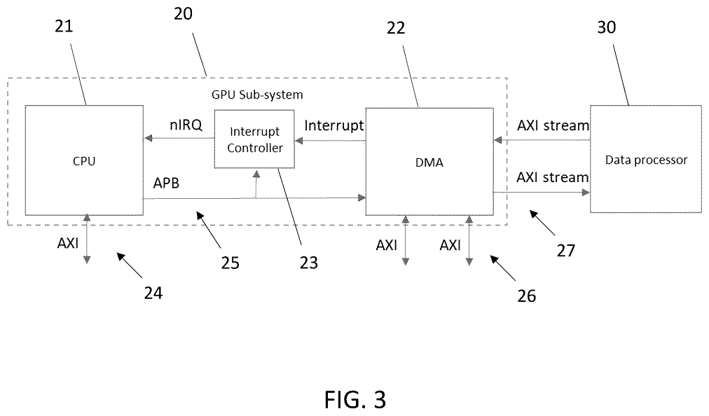

FIG. 3 shows “2-D” graphics sub-system (accelerator) 20 in more detail. As illustrated in FIG. 3, CPU 21 has a memory interface 24 for accessing the system memory 6 via system interconnect 4, and can control DMA controller 22 via a local interface 25. DMA controller 22 has memory interfaces 26 for accessing the system memory 6 via system interconnect 4, and can issue interrupt requests to CPU 21 via interrupt controller 23. As illustrated in FIG. 3, DMA controller 22 also has a “streaming interface” 27 for communicating directly with data processor 30 (e.g. an AMBA AXI streaming interface).

In use, CPU 21 may read commands and data generated by host processor CPU 1 from memory 6, and in response to such commands and data, access memory 6, perform graphics processing operations, control DMA controller 22 to access memory 6 and perform appropriate processing (e.g. data transfer) operations, control data processor 30 to perform processing operations, etc. To do this, firmware running on the CPU 21 may interpret commands provided by the driver executing on the host processor CPU 1, and trigger execution of appropriate software by the CPU 21.

Thus, CPU 21 may perform graphics operations by itself, or in conjunction with DMA controller 22 and/or data processor 30. For example, CPU 21 may perform font rendering or vector graphics operations, and control DMA controller 22 to perform memory copy operations (e.g. while CPU 21 is performing other operations).

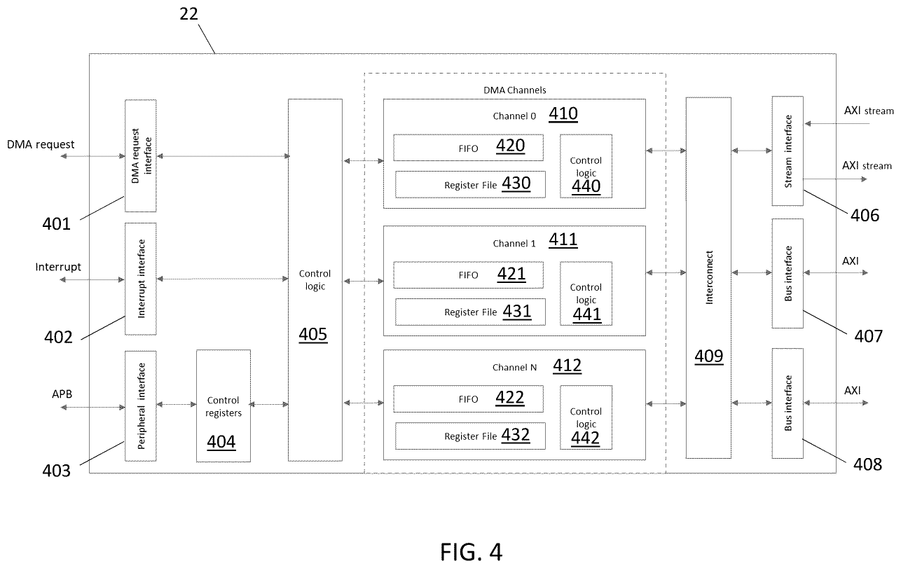

FIG. 4 shows DMA controller (data transfer circuit) 22 in more detail in accordance with embodiments of the technology described herein. As illustrated in FIG. 4, DMA controller 22 includes a number of interfaces, including an interface 401 that can receive DMA requests from CPU 21 (to allow the CPU 21 to program the DMA controller 22 to perform DMA requests), and an interrupt interface 402 that can communicate with interrupt controller 23 (which can send interrupt requests to the CPU 21).

DMA controller 22 may further comprise a peripheral interface 403 that can receive DMA requests from a peripheral device, and an associated set of control registers 404 which can be set for communication with the peripheral device. Peripheral interface 403 may be used to control non-memory to memory DMA transactions, e.g. between memory 6 and a peripheral (e.g. UART) device.

As illustrated in FIG. 4, DMA controller 22 further comprises a streaming interface 406 that can communicate (directly) with data processor 30, and two memory interfaces 407, 408 that can access the system memory 6. Other arrangements and numbers of interfaces would be possible.

As illustrated in FIG. 4, DMA controller 22 is arranged with multiple channels 410-412 that can perform DMA operations independently of each other. FIG. 4 illustrates three DMA channels 410-412, but it will be appreciated that other numbers of channels are possible, such as two, four, eight, sixteen, or another number of channels.

As shown in FIG. 4, each DMA channel 410-412 can communicate with streaming interface 406 and memory interfaces 407, 408 via local interconnect 409. Each DMA channel 410-412 includes a respective set of control registers 430-432 that can be set (independently) by control logic (control circuit) 405 to control operation of the respective channel, and respective channel control logic 440-442 that causes the channel to operate accordingly. Each DMA channel further includes a respective FIFO 420-422 for buffering data being transferred by the respective channel.

In use, when a request to transfer data is received by DMA controller 22 (e.g. from CPU 21), control logic 405 may assign a DMA channel 410-412 to carry out the request by setting the control registers 430-432 of the assigned channel appropriately, and in response, the channel control logic 440-442 of the assigned channel may cause the assigned channel to issue appropriate requests and receive responses via interconnect 409 to cause data to be transferred in accordance with the request.

A channel may, for example, be configured (by control logic 405 setting control registers 430-432) to transfer data between different locations in memory 6 (via memory interface 407, 408), and/or to transfer data between memory 6 and data processor 30 (via streaming interface 406), etc.

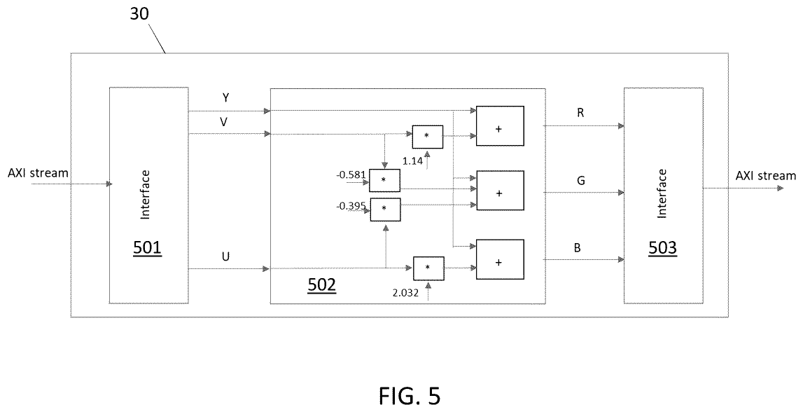

FIG. 5 illustrates an embodiment in which data processor 30 is configured to perform YUV to RGB colour space conversion. Such colour space conversion may be performed by data processor 30 where image data is stored in memory 6 in YUV format but is to be output to display panel 7 in RGB format.

As shown in FIG. 5, in this embodiment, data processor 30 comprises an interface 501 that receives YUV colour data from the streaming interface 406 of the DMA controller 22, colour space converter 502 that converts the YUV colour data to RGB colour data, and an interface 503 that returns the RGB colour data to the streaming interface 406 of the DMA controller 22. Other arrangements are possible.

YUV colours are typically described by a “luma” (Y) value representing the luminance or brightness of the colour, and two “chroma” values (U and V) representing the chrominance information of the colour. In the case of a “YUV” image, for respective data elements within the image, appropriate luma (Y) and chroma (U and V) values will be stored. Where the luma and chroma data for a YUV image are stored at the same resolution, for each data element in the image there will be a respective luma (Y) value and two chroma (U and V) values.

The human eye is more sensitive to brightness than chrominance, so YUV data is usually compressed using a technique called “chroma sub-sampling”. Chroma sub-sampling stores the chroma (U and V) information at a lower resolution than the luma (Y) information. Where the chroma data is sub-sampled, the chroma data will accordingly be stored for and represented in the image at a lower resolution than the luma data. Thus, an array of data elements for which chroma data is stored will be at a lower resolution than an array of data elements for which the luma data is stored.

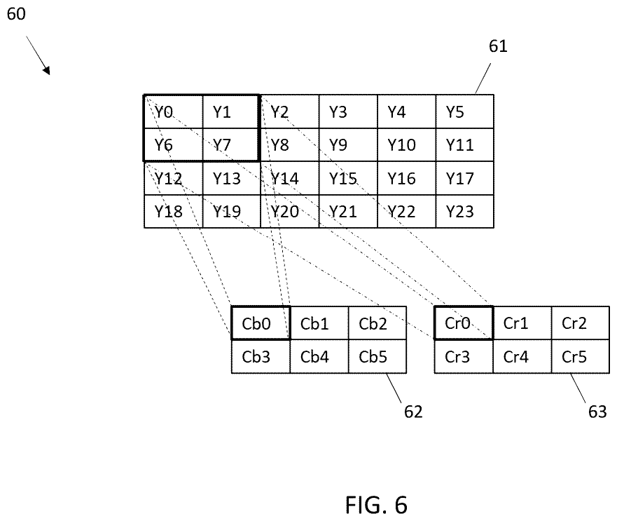

An example of chroma sub-sampling is illustrated by FIG. 6. FIG. 6 illustrates data representing an image 60 that comprises an array of luma information 61 and two arrays 62, 63 of chroma information. As illustrated in FIG. 6, chroma data arrays 62, 63 have a lower resolution than luma data array 61.

FIG. 6 illustrates an example of “YUV420” format, in which chroma data is stored at half the resolution of luma data both horizontally and vertically, such that each chroma data element (sample) has four luma data elements (samples) associated with it. Other chroma sub-sampling formats are possible. For example, in “YUV422” format, chroma data is stored at half the resolution of luma data horizontally but at the same resolution as luma data vertically, such that each chroma data element (sample) will have two luma data elements (samples) associated with it.

In a “planar” memory format, the luma information for an image is stored separately in memory to the chroma information (e.g. in contrast with a “chunky” memory format in which all colour components are stored together in the same buffer). For example, luma data array 61 may be stored in a first region (buffer) of memory 6, and chroma data arrays 62, 63 may be stored together in a second, different region (buffer) of memory 6. Alternatively, chroma data arrays 62, 63 may be stored separately in memory 6, such that the image is stored in three separate memory regions (buffers).

In this embodiment, DMA controller 22 may be configured to use a separate channel to fetch data stored in each separate memory region (buffer). For example, a first DMA channel 410 may be configured to fetch luma data array 61 from memory 6 (via a memory interface 407, 408) and provide the data to data processor 30 for colour space conversion (via streaming interface 406), a second DMA channel 411 may be configured to fetch chroma data array 62 from memory 6 (via a memory interface 407, 408) and provide the data to data processor 30 for colour space conversion (via streaming interface 406), and a third DMA channel 412 may be configured to fetch chroma data array 63 from memory 6 (via a memory interface 407, 408) and provide the data to data processor 30 for colour space conversion (via streaming interface 406).

This can allow the DMA controller 22 to efficiently fetch the separately stored luma and chroma data and provide it to data processor 30 for colour space conversion.

The inventors have realised, however, that when the chroma data is stored at a lower resolution than the luma data, this can result in the chroma data for an image being provided to data processor 30 in a shorter overall time than the associated luma data for the image. Thus, there can be a mismatch between the effective rates at which different DMA channel transfer the luma and chroma data for a given image region (area).

One way to deal with this would be to provide the data processor 30 with sufficient buffer capacity to be able to accommodate this effective data transfer rate mismatch. The inventors have realised, however, that providing such buffer capacity can increase area/silicon cost associated with the data processor 30.

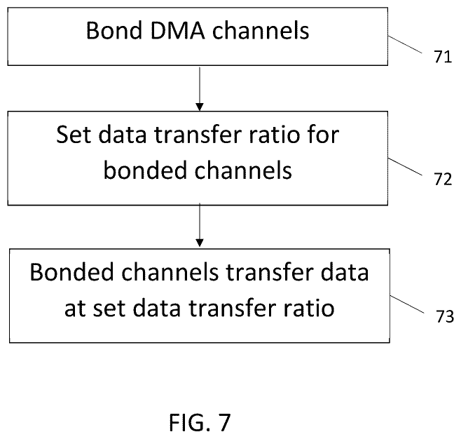

FIG. 7 illustrates a process in accordance with embodiments of the technology described herein. As illustrated in FIG. 7, in embodiments of the technology described herein, two or more DMA channels of DMA controller 22 are bonded together (at step 71), and configured to transfer data at a set ratio relative to each other (at step 72). The bonded channels then transfer data at the set ratio (at step 73).

To facilitate this, DMA control logic 405 may keep track of which channels are bonded together and the associated data transfer ratio, and configure channel control registers 430-432 to cause bonded channels to transfer data at the desired data transfer ratio. The bonded channels may be configured to use the same transaction ID when requesting data from memory 6, so as to cause the memory system 6 to return data in the same order that it was requested. Where the memory system 6 is striped, bonded channels may be configured to use a respective (same) transaction ID for each memory stripe (and a different transaction ID for different memory stripes).

For example, in the YUV420 example of FIG. 6 where first DMA channel 410 transfers data for luma data array 61 to data processor 30, second DMA channel 411 transfers data for chroma data array 62 to data processor 30, and third DMA channel 412 transfers data for chroma data array 63 to data processor 30, the first, second and third DMA channels 410, 411, 412 may be bonded together and configured to transfer data at a ratio of 4:1:1. The first DMA channel 410 will thus transfer data for luma data array 61 to data processor 30 at a rate that is four times higher than a rate at which second channel 411 transfers chroma data to data processor 30 and third DMA channel 412 transfers chroma data to data processor 30.

(Alternatively, a first DMA channel could transfer the luma data, and a second DMA channel could transfer all of the chroma data, with the first and second DMA channels being bonded together and configured to transfer data at a ratio of 2:1.)

The effect of this is that (since the chroma is stored with lower resolution) the bonded DMA channels will provide the data processor 30 with the luma data and chroma data for a given image region at substantially the same effective data transfer rate. This can reduce or avoid buffering capacity requirements associated with data processor 30, and thus save silicon/area cost.

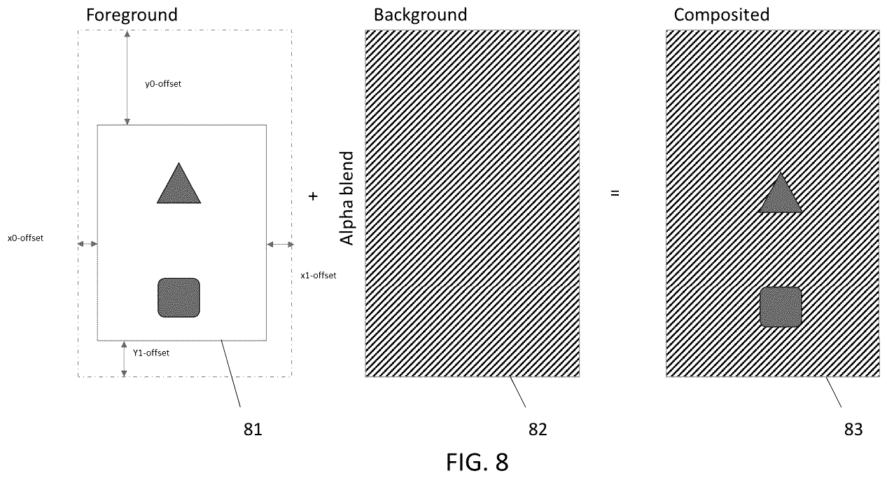

The inventors have furthermore realised that similar issues can arise in other 2-D graphics processing contexts. For example, FIG. 8 illustrates an embodiment in which data processor 30 is configured to perform image compositing. FIG. 8 illustrates an example of foreground image data 81 and background image data 82 that are stored separately in memory 6 and are to be alpha blended by data processor 30 to generate a composited image 83 which is to be written back to memory 6 and/or output on display panel 7. In this example, the foreground image data 81 comprises a window comprising a set of icons, whereas background image data 82 fills the frame. In this embodiment, as well as blending the image element data, data processor 30 may also scale and/or shift image element data (e.g. foreground image data 81).

In this embodiment, a first DMA channel may be configured to fetch foreground data array 81 from memory 6 (via a memory interface 407, 408) and provide the data to data processor 30 for compositing (via streaming interface 406), and a second DMA channel may be configured to fetch background data array 82 from memory 6 (via a memory interface 407, 408) and provide the data to data processor 30 for compositing (via streaming interface 406).

In this embodiment, there is more background data than foreground data, which could result in the data processor 30 receiving the foreground data in a shorter space of time than the corresponding background data. The first and second DMA channels are therefore bonded and configured to transfer data with an appropriate data transfer ratio such that the foreground data and the background data are provided to the data processor 30 in a coordinated manner.

In this embodiment, the DMA controller 22 may also be provided with information indicating the position and size of the foreground data array 81. For example, as illustrated in FIG. 8, the DMA controller 22 may be provided with pixel offset values x0, x1, y0, y1. The DMA controller 22 may use this information to avoid requesting data in respect of frame regions which foreground data array 81 does not cover.

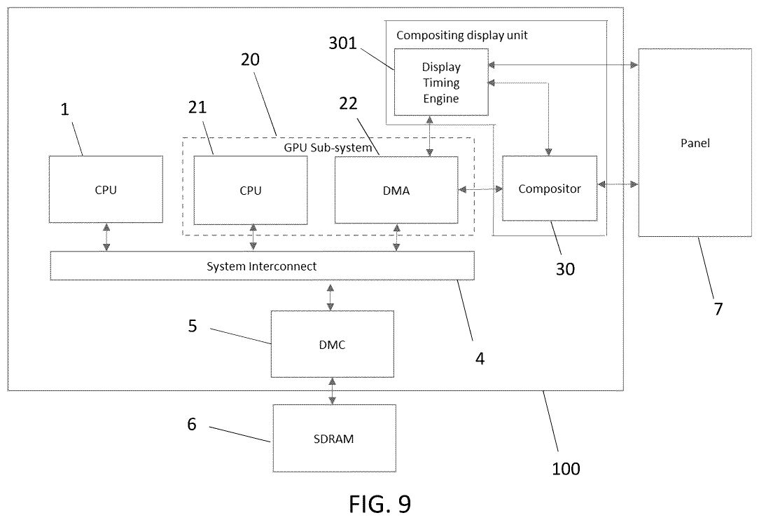

In the embodiments described above, composited/colour converted data output by data processor 30 may be transferred to memory 6 by DMA controller 22, and then read from memory 6 by display controller 3 for display on display panel 7. FIG. 9 illustrates another embodiment in which composited/colour converted data output by data processor 30 can be provided directly to display panel 7 without being written back to memory 6.

As illustrated in FIG. 9, DMA controller 22 is in direct communication with data processor 30 (via a streaming interface), which in this embodiment is configured to perform image compositing. DMA controller 22 is also in communication with display timing engine 301 which sends timing signals to the display panel 7 and initiates DMA requests via DMA request interface 401 (or peripheral interface 403) to cause DMA controller 22 to transfer image data to be composited to data processor 30. Data processor 30 performs image compositing and provides composited images directly to the display panel 7 (e.g. rather than sending the composited images back to memory 6).

The foregoing detailed description has been presented for the purposes of illustration and description. It is not intended to be exhaustive or to limit the technology to the precise form disclosed. Many modifications and variations are possible in the light of the above teaching. The described embodiments were chosen in order to best explain the principles of the technology and its practical application, to thereby enable others skilled in the art to best utilise the technology in various embodiments and with various modifications as are suited to the particular use contemplated. It is intended that the scope be defined by the claims appended hereto.

1. A graphics accelerator comprising:
a data transfer circuit having a set of plural data transfer channels operable to transfer data; and
a control circuit operable to:
associate two or more data transfer channels of the set of plural data transfer channels with each other; and
cause the associated two or more data transfer channels to transfer data at respective data transfer rates in accordance with a particular data transfer rate ratio.

2. The graphics accelerator of claim 1, wherein the data transfer circuit is a Direct Memory Access (DMA) controller, and the graphics accelerator comprises a Central Processing Unit (CPU) operable to control the DMA controller.

3. The graphics accelerator of claim 1, wherein the data transfer circuit comprises one or more memory interfaces for communicating with a memory system; and
the control circuit is operable to cause the associated two or more data transfer channels to transfer data to and/or from the memory system via the one or more memory interfaces at respective data transfer rates in accordance with the particular data transfer rate ratio.

4. The graphics accelerator of claim 3, wherein the control circuit is operable to cause requests to the memory system for the associated two or more data transfer channels to use a same transaction identifier.

5. The graphics accelerator of claim 1, wherein the data transfer circuit comprises one or more interfaces for directly communicating with a data processor; and
the control circuit is operable to cause the associated two or more data transfer channels to transfer data to and/or from the data processor via the one or more interfaces at respective data transfer rates in accordance with the particular data transfer rate ratio.

6. The graphics accelerator of claim 5, wherein the data processor is operable to perform colour space conversion; and
the control circuit is operable to cause the associated two or more data transfer channels to transfer data representing different colour components to and/or from the data processor at respective data transfer rates in accordance with the particular data transfer rate ratio.

7. The graphics accelerator of claim 6, wherein the particular data transfer rate ratio is based on a resolution at which the different colour components are represented.

8. The graphics accelerator of claim 5, wherein the data processor is operable to perform image compositing; and
the control circuit is operable to cause the associated two or more data transfer channels to transfer image element data to be composited to the data processor at respective data transfer rates in accordance with the particular data transfer rate ratio.

9. The graphics accelerator of claim 8, wherein the particular data transfer rate ratio is based on a size of image elements to be composited.

10. The graphics accelerator of claim 5, wherein the data processor is operable to provide output image data for display directly to a display.

11. A data transfer circuit comprising:
a set of plural data transfer channels operable to transfer data; and
a control circuit operable to:
associate two or more data transfer channels of the set of plural data transfer channels with each other; and
cause the associated two or more data transfer channels to transfer data at respective data transfer rates in accordance with a particular data transfer rate ratio.

12. A method of operating a graphics accelerator that comprises a data transfer circuit having a set of plural data transfer channels operable to transfer data; the method comprising:
associating two or more data transfer channels of the set of plural data transfer channels with each other; and
causing the associated two or more data transfer channels to transfer data at respective data transfer rates in accordance with a particular data transfer rate ratio.

13. The method of claim 12, wherein the data transfer circuit comprises one or more memory interfaces for communicating with a memory system; and the method comprises:
causing the associated two or more data transfer channels to transfer data to and/or from the memory system via the one or more memory interfaces at respective data transfer rates in accordance with the particular data transfer rate ratio.

14. The method of claim 13, comprising causing requests to the memory system for the associated two or more data transfer channels to use a same transaction identifier.

15. The method of claim 12, wherein the data transfer circuit comprises one or more interfaces for directly communicating with a data processor; and the method comprises:
causing the associated two or more data transfer channels to transfer data to and/or from the data processor via the one or more interfaces at respective data transfer rates in accordance with the particular data transfer rate ratio.

16. The method of claim 15, wherein the data processor is operable to perform colour space conversion; and the method comprises:
causing the associated two or more data transfer channels to transfer data representing different colour components to and/or from the data processor at respective data transfer rates in accordance with the particular data transfer rate ratio.

17. The method of claim 16, wherein the particular data transfer rate ratio is based on a resolution at which the different colour components are represented.

18. The method of claim 15, wherein the data processor is operable to perform image compositing; and the method comprises:
causing the associated two or more data transfer channels to transfer image element data to be composited to the data processor at respective data transfer rates in accordance with the particular data transfer rate ratio.

19. The method of claim 18, wherein the particular data transfer rate ratio is based on a size of image elements to be composited.

20. A non-transitory computer readable storage medium storing software code which when executing on a processor performs the method of claim 12.
